(19) United States
(12) Patent Application Publication
(10) Pub. No.: US 2019/0128576 A1
(43) Pub. Date: May 2, 2019

(54) TEMPERATURE RESPONSIVE LIQUID FLOW REGULATOR

(71) Applicant: Ford Global Technologies, LLC, Dearborn, MI (US)

(72) Inventors: Christopher James Leck, Enfield (GB); Duncan Scholtes, London (GB)

(21) Appl. No.: 16/156,642

(22) Filed: Oct. 10, 2018

(30) Foreign Application Priority Data
Oct. 31, 2017 (GB) 1717972.2

(51) Int. Cl. F25B 41/04; G05D 23/02; F01P 7/14

(52) U.S. Cl. CPC F25B 41/04; G05D 23/022; F25B 2600/2515; F01P 2007/146; F01P 7/14

(57) ABSTRACT

Methods and systems are provided for a multi-way valve. In one example, a system may comprise a multi-way valve comprising a regulator material arranged in a toroidal, flexible housing arranged in a passage shaped to flow a fluid. The regulator material may phase change in response to a temperature of the fluid, wherein the phase change may result in a constriction of a flow-through area of the passage.

### CROSS REFERENCE TO RELATED APPLICATION

The present application claims priority to Great Britain patent application No. 1717972.2, entitled “A Temperature Responsive Liquid Flow Regulator”, and filed on Oct. 31, 2017. The entire contents of the above-listed application are hereby incorporated by reference for all purposes.

### FIELD

The present description relates generally to controlling the flow of liquid through a passage and to a temperature responsive flow regulator for controlling the flow of liquid through a passage.

### BACKGROUND/SUMMARY

Engines may utilize various control systems for allowing various fluids to flow harmoniously through passages of an engine system to attain desired emissions levels and power output. Control systems may comprise one or more valves or other metering devices to adjust flows from one region of the engine system to another.

Valves and the like may feature a variety of shapes and configurations for metering fluid flow. For example, a check valve may comprise a spring element or other similar feature for adjusting a flow of a fluid in response to an external stimulus (e.g., pressure). As another example, a control valve may comprise one or more moveable elements configured to actuate in response to signals received from an electronic controller. As such, the control valve may provide a greater range of control, with the downside of being more expensive than the check valve. Thus, it may be desired to arrange a valve free of electronic controls with an element configured to provide a greater range of control. Furthermore, valves may become increasingly complex as more than one passage is arranged therein, also known by those of ordinary skill in the art as a multi-way valve.

One of the problems with such an arrangement may be that the construction of such a combined bypass and thermostat in a multi-way valve is relatively complex in construction in order to get the two valve portions to function correctly when subject to a potentially mixed fluid flow and may be difficult to package in a single compact unit. One example of a combined bypass and thermostat and its use is disclosed in GB Patent 2,320,552.

However, the inventors herein have recognized potential issues with such systems. As one example, the valve of the previous example may demand complex controls executed via a controller or the like, which may be expensive. Additionally, electronic components used to transmit signals to the combined valve may be prone to degradation.

In one example, the issues described above may be addressed by a system comprising a multi-way valve comprising a regulator material arranged within a toroidal, flexible housing shaped to expand and contract in response to a phase change of the regulator material. In this way, the multi-way valve may be free of electrical connections while providing increased functionality.

As another example, a temperature responsive liquid flow regulator comprising a temperature responsive regulator member held captive within a passage so as to define an orifice through which liquid flows in use, the temperature responsive regulator member comprising a continuous resilient hollow ring having a flexible wall defining a chamber within the hollow ring that is filled with a regulator material having a predefined state change temperature, when the temperature of a liquid in the passage is lower than the predefined state change temperature the regulator material is in a solid state and a flow area of the orifice is at a maximum and when the temperature of the liquid in the passage is higher than the predefined state change temperature the regulator material transforms into a liquid state wherein the diameter of the orifice defined by the regulator member varies from a maximum diameter when the regulator material is in the solid state to a minimum diameter when the regulator material is in the liquid state and the flow area of the orifice reduces in proportion to the increase in temperature of the liquid above the predefined state change temperature until a minimum flow area corresponding to the minimum diameter is reached.

In one example, the regulator material may be a wax based material shaped to phase change in response to a temperature of liquid and/or gas flowing through the passage. During the phase change, the regulator material may expand or contract, wherein expansion of the regulator material may result in a restriction of the passage and where a contraction of the regulator material may result in less restriction of the passage. The continuous hollow ring may be made from one or more of rubber and elastomer and may comprise a toroidal shape. The continuous hollow ring may be circular in cross-section when the regulator material is in the solid state. The continuous hollow ring may be oblong in cross-section, or other deviation from circular when the regulator material is in a liquid state. A flow area, which may correspond to an opening of the continuous hollow ring may be smaller when the regulator material is in the liquid state compared to the solid state. In one example, the minimum flow area may be substantial equal to zero.

According to a second aspect of the disclosure there is provided a motor vehicle liquid cooling system having a conduit defining a liquid flow passage and the temperature responsive liquid flow regulator constructed to regulate the flow of liquid through the conduit based upon the temperature of the liquid flowing through the conduit. The liquid cooling system may be an engine cooling system and the liquid is engine coolant. The conduit may be a radiator bypass passage and the temperature responsive liquid flow regulator may control the flow of coolant through the radiator bypass passage. Alternatively, the conduit may be a supply conduit to an automatic transmission warm up unit and the flow regulator may control the flow of coolant through the supply conduit. As yet another alternative, the conduit may be a return conduit from an automatic transmission warm up unit and the flow regulator may control the flow of coolant through the return conduit.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1A shows a cross-section through a temperature responsive liquid flow regulator showing a temperature responsive regulator member in a minimum flow restricting state.

FIG. 1B shows an end view of the temperature responsive regulator member.

FIG. 2 shows a cross-section through the temperature responsive liquid flow regulator showing a temperature responsive regulator member in a maximum flow restricting state.

FIG. 3 shows a schematic diagram of part of a previous example of a motor vehicle engine cooling system including a combined thermostat and bypass valve.

FIG. 4 shows a schematic diagram of part of a motor vehicle in accordance with a first embodiment of a second aspect of the present disclosure showing the use of a temperature responsive liquid flow regulator.

FIG. 5 is a schematic diagram of part of a prior art motor vehicle engine cooling system including a three way valve for controlling flow to an automatic transmission warm up unit.

FIG. 6 is a schematic diagram of part of a motor vehicle in accordance with a second embodiment of the second aspect of the disclosure showing the use of a temperature responsive liquid flow regulator in accordance with the first aspect of the disclosure.

FIG. 7 is a cross-section through an alternative embodiment of a flow regulator according to the disclosure.

### DETAILED DESCRIPTION

The following description relates to systems and methods for a multi-way valve comprising a regulator material which may be reactive to an external stimulus. The regulator material may phase change in response to a temperature of a fluid flowing through a passage in which the multi-way valve is arranged. The regulator material may be housed within a flexible material comprising a shape such that the flexible material defined an opening diameter of the passage based on the phase of the regulator material.

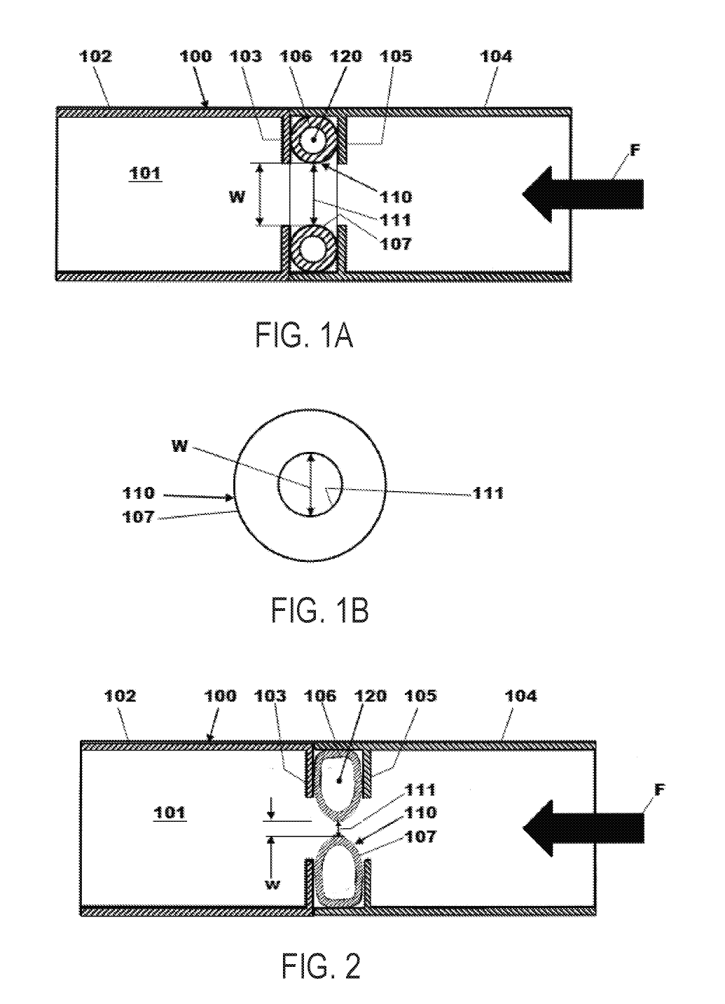

FIGS. 1A and 2 illustrate open and closed positions of the multi-way valve, respectively. In the open position, the regulator material may be in the solid phase and as such, fluids flowing through the passage may comprise a temperature less than a predetermined temperature, wherein the predetermined temperature is based on a melting temperature of the regulator material. In the closed position, the regulator material may be in the liquid phase and as such, a temperature of fluids flowing through the passage may be greater than the predetermined temperature. It will be appreciated by those of ordinary skill in the art that for fluids comprising a temperature substantially equal to the predetermined temperature (e.g., within ±5 degrees), then the regulator material may be at an interface between solid and liquid. In one example, the regulator material may begin to “sweat”, wherein portions of the regulator material are melted to liquid and other portions are still solid. This may result in a partial position between the open and closed positions illustrated in FIGS. 1A and 2. There may be a plurality of partial positions, wherein a constriction provided by the partial position may be based on an amount of the regulator material transitioned to the liquid phase. Thus, as more of the regulator material transitions to the liquid phase, the constriction may increase, thereby decreasing fluid flow through the passage.

A face-on view of the multi-way valve is shown in FIG. 1B, wherein the face-on view further illustrates the open position illustrated in FIG. 1A. In the face-on view, a toroidal shape and/or ring shape of the flexible material housing the regulator material is realized. As such, a central opening of the flexible material may be substantially equal to flow-through area of the passage. As such, as the central opening becomes more constricted, due to an expansion of the regulator material, then the flow-through area of the passage may decrease, thereby allowing less fluid to flow through the passage. In this way, the flexible material may be concentric with a tube or other housing of the passage about a central axis of the passage, wherein a flow direction of fluid is parallel to the central axis.

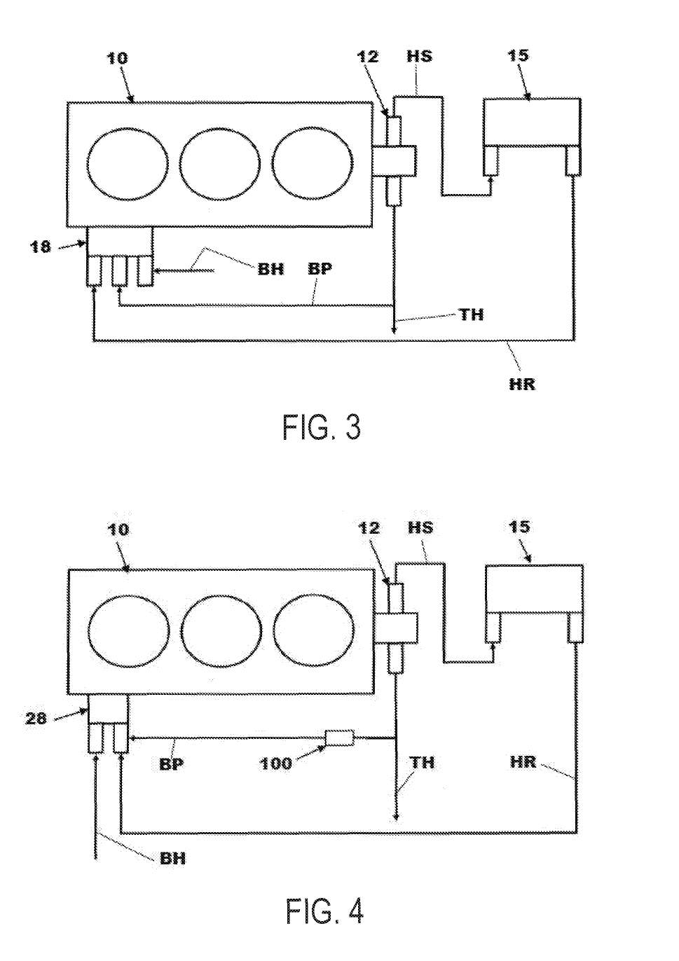

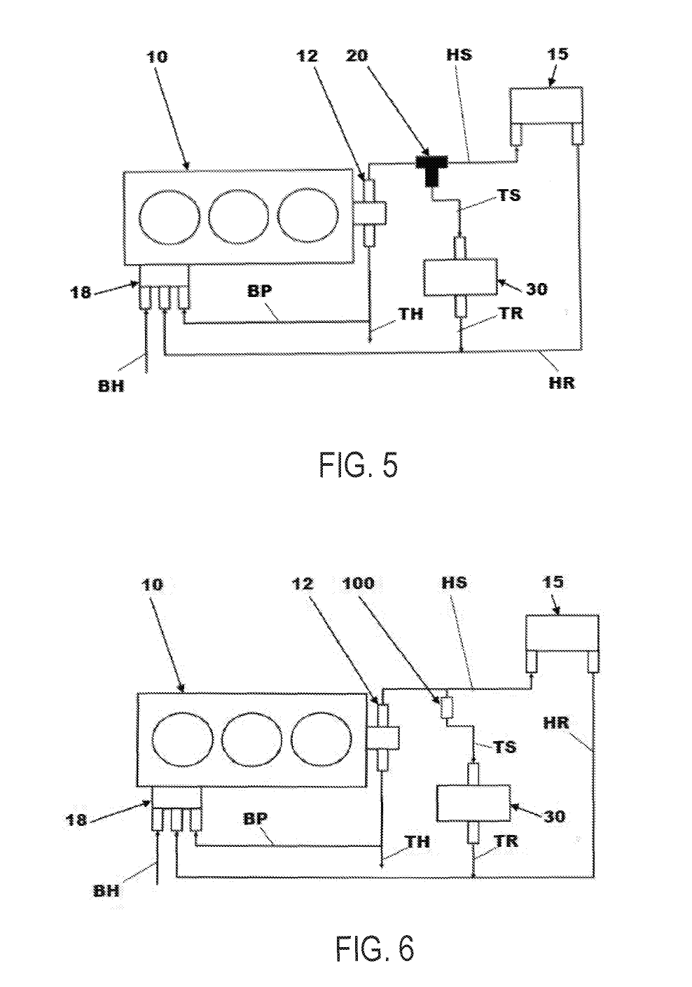

FIGS. 3, 4, 5, and 6 illustrate various embodiments of an engine system, wherein the multi-way valve is arranged to meter different types of flows. In the examples of FIGS. 3 and 4, the multi-way valve is positioned to meter coolant flow to a coolant radiator, wherein coolant flow to the radiator may be bypassed during a warm-up phase and/or cold-start of an engine. In the examples of FIGS. 5 and 6, the multi-way valve is positioned to adjust coolant flow to a heat exchanger unit, wherein coolant flow to the heat exchanger unit is permitted during a warm-up phase and/or cold-start of an engine. It will be appreciated that the multi-way valve may be positioned in other embodiments, additionally or alternatively, to adjust oil, exhaust gas, and other fluid flows. For example, the multi-way valve may be positioned to meter exhaust gas flow from an exhaust passage to an intake passage, known as exhaust-gas recirculation (EGR).

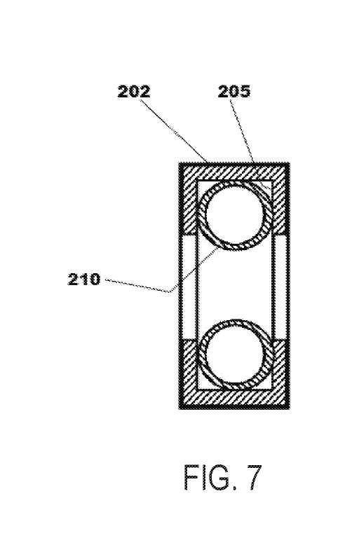

FIG. 7 shows an alternate embodiment of the multi-way valve, wherein the valve may be arranged in a groove or the like of a passage.

FIGS. 1A-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

With reference to FIGS. 1A, 1B, and 2, which are diagrammatic in nature, there is shown a temperature responsive liquid flow regulator 100 having a temperature responsive regulator member 110 held captive within a liquid flow passage 101 by a pair of inwardly directed annular flanges 103, 105 so as to define an orifice 111 through which liquid may flow. The direction of liquid flow through the passage 101 is indicated by the arrow F in the example of FIGS. 1A and 2 but it will be appreciated that the temperature responsive liquid flow regulator 100 will work in the same manner irrespective of direction of flow through the passage 101.

The flow regulator 100 in the case of this example may comprise of first and second tubular members 102, 104 which in combination define the liquid flow passage 101. A first annular flange 103 of the pair of inwardly directed annular flanges 103, 105 may be formed as an integral part of the first tubular member 102 and a second annular flange 105 of the pair of inwardly directed annular flanges 103, 105 may be formed as an integral part of the second tubular member 104. It will be appreciated that the disclosure is not limited to such an arrangement of tubular members and flanges and that other arrangements for holding the temperature responsive regulator member 110 captive in a liquid flow passage could be used.

For example, the temperature responsive regulator member could be fitted into an internal circumferential groove in a tube. FIG. 7 shows such an arrangement in which a tube 202 may be arranged in an internal circumferential groove 205 having a temperature responsive regulator member 210.

Returning to FIGS. 1A, 1B, and 2, the temperature responsive regulator member 110 may comprise a continuous hollow ring 107 comprising a resilient material having a flexible wall defining a chamber 106 within the hollow ring 107. The chamber 106 is substantially filled with a regulator material 120 having a predefined state change temperature falling within a predefined temperature range such as, for example, 90 to 120° C. In the case of the embodiment shown in FIGS. 1A, 1B, and 2, the regulator member 110 is toroidal in shape.

When the regulator material 120 is in a solid state the regulator member 110 is circular in cross-section and when the regulator material 120 is in a liquid state the regulator member 110 is deformed from the circular cross-sectional shape to a flattened oval in cross-section. However, it will be appreciated that other original and final cross-sectional shapes are possible.

It will be appreciated that an outer circumference of the hollow ring 107 abuts and reacts against an inner surface of the second tubular member 104 and so the hollow ring 107 is deformed primarily inwardly when the regulator material 120 expands.

The hollow ring 107 may comprise a flexible material such as rubber or elastomer so that it can be deformed by the regulator material 120 located in the chamber 106 when the regulator material undergoes a state change from solid to liquid.

The regulator material 120 in the example of FIGS. 1A, 1B, and 2 may comprise a wax based material. It will be appreciated that by blending two or more waxes the temperature at which the resultant wax based material will change state from solid to liquid known as the “state change temperature” can be adjusted to occur within a predefined temperature range. Alternatively, a single wax can be used having a state change temperature meeting demands for the intended use.

When the regulator material 120 melts due to its temperature exceeding its state change temperature, the resulting expansion of the regulator material 120 causes the cross-sectional shape of the hollow ring 107 to change due to increased pressure in the chamber 106 so as to adopt the flattened oval cross-section shape as shown in FIG. 2. This change in cross-sectional shape from circular to a flattened oval has the effect of reducing the diameter of the orifice 111 defined by the regulator member 110 from a maximum diameter ‘W’ when the regulator material 120 is in the solid state (shown in FIGS. 1A and 1B) to a minimum diameter ‘w’ (shown in FIG. 2) when the regulator material 120 is in the liquid state. It will be appreciated that the forces produced by the regulator material 120 may be counteracted by tension forces in the flexible wall of the hollow ring 107 due to the expansion of the regulator material 120 and that eventually a force balance is achieved which corresponds to the minimum diameter ‘w’ of the orifice 111.

It will be appreciated that the orifice 111 provides a maximum flow area when the diameter is “W” and the regulator material 120 is in the solid state and provides a minimum flow area when the orifice diameter is “w”, wherein the orifice diameter, “w” corresponds to when the regulator material 120 in in the liquid state. Therefore, the temperature responsive regulator member 110 acts so as to regulate the flow of liquid through the passage 101 based upon temperature. It will be appreciated that the regulator material 120 may be adjusted in composition via inclusion of one or more waxes so as to adjust the orifice diameter from “w” to some other diameter based on demands of other systems. In one example, the orifice diameter may be equal to zero such that liquid may not flow through the passage 101.

It will be appreciated that when the temperature of the regulator material 120 changes from a temperature lower than the state change temperature to a temperature higher than the state change temperature the regulator material 120 will melt and expand. It will be appreciated that the coefficient of thermal expansion of a wax based regulator material during such a solid to liquid state change is often an order of magnitude greater than an average coefficient of thermal expansion for such a material. It will be further appreciated that the regulator material 120 may phase change to achieve a plurality of orifice diameters between “W” and “w”, wherein the plurality of orifice diameters may be based on a transition of the regulator material 120 changing from solid to liquid or vice-versa. For example, as some of the regulator material 120 begins to melt from solid to liquid, the orifice diameter may decrease from “W” to an orifice diameter less than “W’ and greater than “w.” In this way, the temperature responsive liquid flow regulator 100 may be shaped to allow partial flows through the passage 101.

In operation the temperature responsive liquid flow regulator 100 is placed in a flow path of liquid that desires regulation based upon temperature. Two non-limiting examples of such use are described hereinafter with reference to FIGS. 3, 4, 5, and 6.

When the temperature of the liquid flowing through the passage 101 which forms part of the liquid flow path is lower than the predefined state change temperature of the regulator material 120 the regulator material 120 is in a solid state and the flow area of the orifice 111 will be at a maximum thereby producing minimum restriction to the flow of liquid through the passage 101. The minimum restriction may be based on a protrusion of one or more of the first and second annular flanges 103, 105. In this way, a protrusion of the regulator member 110 when the temperature of the liquid flowing through the passage 101 is lower than the predefined state change temperature of the regulator material 120 may be less than or equal to a protrusion of the first and second annular flanges 103, 105. It will be appreciated that the temperature of the liquid flowing through the orifice 111 defined by the hollow ring 107 may directly affect the temperature of the regulator material 120 due to heat conduction through the wall of the hollow ring 107.

When the temperature of the liquid flowing through the orifice 111 is increased to a temperature higher than the predefined state change temperature of the regulator material 120, the regulator material 120 may transform and/or melt and/or phase change into the liquid state and the flow area of the orifice 111 reduces in proportion to the increase in temperature of the liquid above the predefined state change temperature of the regulator material 120 until a minimum flow area is reached. The minimum flow area may directly correspond to a protrusion of the regulator member 110 into the passage 101. As described above, the protrusion of the regulator member 110 may be dependent on a composition of phase changing material(s) arranged within the hollow ring 107 of the regulator member 110.

By arranging the state change temperature of the regulator material 120 to be substantially at a desired control temperature, the temperature responsive liquid flow regulator 100 can be used to control or regulate the flow of liquid in a simple manner based upon the temperature of the liquid flowing therethrough without use of complex hardware, electronic valves, or the like. As such, the liquid flow regulator 100 may decrease packaging constraints, increase energy economy, and increase simplicity of a system.

With reference to FIG. 3 there is shown a portion of a previous example of a motor vehicle engine cooling system. The cooling system comprises in this case an engine 10, a coolant circulation pump (not shown), a radiator (not shown), a heater flow control valve 12, a cabin heater 15, and a combined bypass and thermostat 18. Coolant flows in the direction shown via a bottom hose BH connected from the radiator to the combined bypass and thermostat 18. Coolant flows back to the radiator via a top hose return TH connected to one outlet from the heater flow control valve 12. A radiator bypass passage BP is arranged to bypass the radiator and is connected between the top hose return TH and a bypass inlet of the combined bypass and thermostat valve 18. The cabin heater 15 is connected to the heater flow control valve 12 by a heater supply hose HS and is connected via a heater return hose HR to an inlet of the combined bypass and thermostat 18.

As is well known in the art, the heater flow control valve 12 may be used to regulate the flow of coolant through the cabin heater 15. The combined bypass and thermostat valve 18 is arranged such that after a main thermostat valve of the combined bypass and thermostat valve 18 has opened a bypass valve member also forming part of the combined bypass and thermostat 18 is moved to a closed position. This closing of the bypass valve normally occurs when the temperature of the coolant is approximately 5 to 10 degrees Celsius higher than the opening temperature of the main thermostat valve.

The effect of this opening and closing of bypass valve may be to allow coolant to bypass the radiator during initial warm-up of the engine 10 when the bypass valve is in an open position but then restrict or prevent the flow of coolant through the bypass passage BP at higher temperatures so as to ensure that most of the coolant passes through the radiator thereby maximizing cooling of the coolant.

One of the problems with such an arrangement is that the construction of such a combined bypass and thermostat is relatively complex in construction in order to get the two valves to function correctly when subject to a potentially mixed coolant flow and is difficult to package in a single compact unit. One example of such a combined bypass and thermostat and its use is disclosed in GB Patent 2,320,552. Furthermore, such a valve may demand complex controls executed via a controller or the like, which may be expensive. Additionally, electronic components used to transmit signals to the combined valve may be prone to degradation.

With reference to FIG. 4, there is shown a first embodiment for the temperature responsive liquid flow regulator 100 of FIGS. 1A, 1B, and 2 included in the previously described motor vehicle engine cooling system of the type previously described with reference to FIG. 3 with the exception that the combined bypass and thermostat is replaced by a simple thermostat 28 and the temperature responsive liquid flow regulator 100 is placed in the bypass passage BP.

The temperature responsive liquid flow regulator 100 may be shaped to allow the flow of coolant from the top hose return TH through the radiator bypass passage BP to the thermostat 28 below a predefined temperature and restrict the flow through the radiator bypass passage BP above this temperature by using a regulator material (e.g., regulator material 120 of FIGS. 1A and 2) that changes state substantially at the predefined temperature.

By using such an arrangement there is no need to link the control of flow through the bypass passage BP to the opening and closing of the thermostat valve and so more flexibility of a layout of the engine thermal management system can be provided. In addition, the thermostat can be of a simple more compact and hence easier to package and of a more economical design as it only has one function and not two to perform.

It will also be appreciated that such a temperature responsive liquid flow regulator has no moving parts to wear or potentially become jammed. In this way, the temperature responsive flow regulator 100 may be in a more open position during a cold-start, where coolant temperatures are below the predefined temperature, thereby allowing coolant to flow through the bypass passage BP to heat up more quickly than if the coolant was flowed to the radiator. Once the coolant temperature is greater than the predefined temperature, the temperature responsive flow regulator 100 may move to a more closed position, wherein coolant flow through the bypass passage BP may be reduced or prevented, thereby allowing more coolant to flow through the radiator to increase cooling.

With reference to FIG. 5 there is shown part of a second embodiment of a prior art motor vehicle engine cooling system. As before, the cooling system comprises an engine 10, a coolant circulation pump (not shown), a radiator (not shown), a heater flow control valve 12, a cabin heater 15 and a combined bypass and thermostat 18 but, in addition, includes a three way electronically controlled valve 20 and an automatic transmission warm up unit 30.

The three way valve 20 is located in the coolant flow path from the heater flow control valve 12 to the cabin heater 15 and is arranged to control the flow of coolant to the automatic transmission warm up unit 30 that is used to warm up oil used in an automatic transmission of the motor vehicle following a cold start.

General operation of the cooling system may be substantially similar to the description of the cooling system described with respect to FIG. 3 and is not described again in detail for reasons of brevity.

In the case of this embodiment, during engine warm up following a cold start the three way valve 20 allows coolant to flow via a transmission warm up supply conduit TS to the transmission warm up unit 30. The coolant is returned from the automatic transmission warm up unit 30 via a return conduit TR to the heater return hose HR.

When the transmission has warmed up sufficiently the three way valve 20 closes and coolant can no longer flow to the transmission heater warm up unit 30.

With reference to FIG. 6, there is shown a second embodiment for the temperature responsive liquid flow regulator 100 of FIGS. 1A and 2B, wherein the temperature responsive liquid flow regulator 100 may be arranged in the cooling system. The cooling system arrangement is substantially similar to the cooling system of FIG. 5 with the exception that the three-way electronically controlled valve 20 is replaced by a temperature responsive liquid flow regulator 100. The temperature responsive liquid flow regulator 100 is positioned in the supply conduit TS to the automatic transmission warm up unit 30.

The temperature responsive liquid flow regulator 100 is designed to allow the flow of coolant from the heater supply hose HS to the automatic transmission warm up unit 30 below a predefined temperature and restrict the flow above this temperature by using a regulator material that changes state substantially at the predefined temperature.

By using such an arrangement, a simple more economical arrangement is provided that does not demand the use of relatively expensive electronically controlled valve or an electronic controller to control such a valve. A further advantage is that the temperature responsive liquid flow regulator is self-controlling based upon coolant temperature and free of electronic, pneumatic, mechanical, and other couplings.

It will be appreciated that the temperature responsive liquid flow regulator 100 could be located in the return conduit TR from the automatic transmission warm up unit 30 rather than the supply conduit TS if so desired.

It will also be appreciated that the use of a temperature responsive liquid flow regulator 100 as shown and described with respect to FIG. 4 could be combined with the use of a temperature responsive liquid flow regulator 100 as shown and described with respect to FIG. 6 in a single engine cooling system.

It will also be appreciated that a temperature responsive liquid flow regulator such as the temperature responsive liquid flow regulator 100 could be used in other applications where the flow of liquid based upon temperature is desired within a temperature range suitable for use of such a regulator material and that the disclosure is not limited to the two example uses described above.

It will be appreciated by those skilled in the art that although the disclosure has been described by way of example with reference to one or more embodiments it is not limited to the disclosed embodiments and that alternative embodiments could be constructed without departing from the scope of the disclosure as defined by the appended claims.

In this way, a three-way valve may comprise a regulator material housed within a donut and/or a toroid shaped housing, wherein the housing comprises a flexible material shaped to expand and/or contract in response to a phase change of the regulator material. The regulator material and its housing may be arranged in an outer circumference of a passage, wherein a central opening of the housing may correspond to a flow-through area of the passage. The technical effect of arranging the regulator material with phase-changing properties in the flexible housing may allow the three-way valve to provide increased control and functionality with reduced manufacturing costs. Furthermore, the toroid shape of the housing may allow the three-way valve to be easily retro-fitted into preexisting passages, thereby providing simple assembly and installation. The three-way valve may be less likely to degrade than more complex three-way valve with electronic controls.

An example of a system comprising a multi-way valve comprising a regulator material arranged within a toroidal, flexible housing shaped to expand and contract in response to a phase change of the regulator material. A first example of the system further includes where the multi-way valve is arranged in a passage shaped to flow one or more of a liquid and a gas, and a flow-through area of the passage is equal to a central opening of the toroidal housing. A second example of the system, optionally including the first example, further includes where the central opening is adjustable in response to a fluid temperature, and where the central opening decreases in response to a fluid temperature being greater than a predetermined temperature, and where the central opening increases in response to the fluid temperature being greater than the predetermined temperature. A third example of the system, optionally including one or more of the first and/or second examples, further includes where the predetermined temperature is based on a phase-changing temperature of the regulator material. A fourth example of the system, optionally including one or more of the first through third examples, further includes where the housing and a tube of the passage are concentric about a central axis of the passage, and where a flow direction of fluid is parallel to the central axis. A fifth example of the system, optionally including one or more of the first through fourth examples, further includes where the housing comprises a circular cross-section when the regulator material is in a solid phase. A sixth example of the system, optionally including one or more of the first through fifth examples, further includes where the housing comprises a non-circular cross-section when the regulator material is in a liquid phase.

An example of a temperature response liquid flow regulator comprising a temperature responsive regulator member arranged along a passage shaped to define an orifice through which liquid flows, the temperature responsive regulator member comprising a continuous resilient hollow ring having a flexible wall defining a chamber within the hollow ring filled with a regulator material having a predefined state change temperature, wherein when the temperature of a liquid in the passage is lower than the predefined state change temperature the regulator material is in a solid state and a flow area of the orifice is at a maximum and when the temperature of the liquid in the passage is higher than the predefined state change temperature the regulator material transforms into a liquid state wherein the diameter of the orifice defined by the regulator member varies from a maximum diameter corresponding to when the regulator material is in the solid state to a minimum diameter when the regulator material is in the liquid state and the flow area of the orifice reduces in proportion to the increase in temperature of the liquid above the predefined state change temperature until a minimum flow area corresponding to the minimum diameter is reached. A first example of the temperature responsive liquid flow regulator further comprises where the regulator material comprises wax. A second example of the temperature responsive liquid flow regulator, optionally including the first example, further includes where the continuous hollow ring comprises one or more of rubber and elastomer. A third example of the temperature responsive liquid flow regulator, optionally including the first and/or second examples, further includes where the continuous hollow ring comprises a toroid shape. A fourth example of the temperature responsive liquid flow regulator, optionally including one or more of the first through third examples, further includes where the continuous hollow ring comprises a circular cross-section when the regulator material is in the solid state. A fifth example of the temperature responsive liquid flow regulator, optionally including one or more of the first through fourth examples, further includes where the minimum flow area is equal to zero.

An embodiment of an engine system comprising a cooling system comprising at least one conduit comprising a passage through which a fluid flows based on a temperature, and where the temperature of the fluid being greater than a predetermined temperature closes the passage via a regulator material arranged in a three-way valve phase changing from a solid phase to a liquid phase. A first example of the engine system further includes where the regulator material is arranged in a toroid shaped flexible housing, and where the flexible housing comprises a central opening, a diameter of the central opening is adjusted in response to the phase of the regulator material. A second example of the engine system, optionally including the first example, further includes where a flow rate of fluid through the passage is inversely proportional to the temperature of the fluid, and where the flow rate decreases as the temperature of the fluid increases, and where the flow rate increases as the temperature of the fluid decreases. A third example of the engine system, optionally including the first and/or second examples, further includes where the conduit is a radiator bypass passage and where the three-way valve adjusts the flow of coolant through the radiator bypass passage, wherein the temperature of the fluid is greater than the predetermined temperature following completion of a cold-start of an engine of the engine system. A fourth example of the engine system, optionally including one or more of the first through third examples, further includes where the cooling system comprises coolant, and where the at least one conduit is a supply conduit to a transmission warm-up unit and where the three-way valve adjusts the flow of coolant through the supply conduit. A fifth example of the engine system, optionally including one or more of the first through fourth examples, further includes where the at least one conduit is a return conduit shaped to flow coolant from a transmission warm-up unit to the cooling system, and where the three-way valve adjusted the flow of liquid through the return conduit. A sixth example of the engine system, optionally including one or more of the first through fifth examples, further includes where the three-way valve is free of electrical connections.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system comprising:
a multi-way valve comprising a regulator material arranged within a toroidal, flexible housing shaped to expand and contract in response to a phase change of the regulator material.

2. The system of claim 1, wherein the multi-way valve is arranged in a passage shaped to flow one or more of a liquid and a gas, and a flow-through area of the passage is equal to a central opening of the toroidal housing.

3. The system of claim 2, wherein the central opening is adjustable in response to a fluid temperature, and where the central opening decreases in response to a fluid temperature being greater than a predetermined temperature, and where the central opening increases in response to the fluid temperature being greater than the predetermined temperature.

4. The system of claim 3, wherein the predetermined temperature is based on a phase-changing temperature of the regulator material.

5. The system of claim 2, wherein the housing and a tube of the passage are concentric about a central axis of the passage, and where a flow direction of fluid is parallel to the central axis.

6. The system of claim 1, wherein the housing comprises a circular cross-section when the regulator material is in a solid phase.

7. The system of claim 1, wherein the housing comprises a non-circular cross-section when the regulator material is in a liquid phase.

8. A temperature response liquid flow regulator comprising:
a temperature responsive regulator member arranged along a passage shaped to define an orifice through which liquid flows, the temperature responsive regulator member comprising a continuous resilient hollow ring having a flexible wall defining a chamber within the hollow ring filled with a regulator material having a predefined state change temperature, wherein when the temperature of a liquid in the passage is lower than the predefined state change temperature the regulator material is in a solid state and a flow area of the orifice is at a maximum and when the temperature of the liquid in the passage is higher than the predefined state change temperature the regulator material transforms into a liquid state wherein the diameter of the orifice defined by the regulator member varies from a maximum diameter corresponding to when the regulator material is in the solid state to a minimum diameter when the regulator material is in the liquid state and the flow area of the orifice reduces in proportion to the increase in temperature of the liquid above the predefined state change temperature until a minimum flow area corresponding to the minimum diameter is reached.

9. The temperature responsive liquid flow regulator of claim 8, wherein the regulator material comprises wax.

10. The temperature responsive liquid flow regulator of claim 8, wherein the continuous hollow ring comprises one or more of rubber and elastomer.

11. The temperature responsive liquid flow regulator of claim 8, wherein the continuous hollow ring comprises a toroid shape.

12. The temperature responsive liquid flow regulator of claim 8, wherein the continuous hollow ring comprises a circular cross-section when the regulator material is in the solid state.

13. The temperature responsive liquid flow regulator of claim 8, wherein the minimum flow area is equal to zero.

14. An engine system comprising:
a cooling system comprising at least one conduit comprising a passage through which a fluid flows based on a temperature, and where the temperature of the fluid being greater than a predetermined temperature closes the passage via a regulator material arranged in a three-way valve phase changing from a solid phase to a liquid phase.

15. The engine system of claim 14, wherein the regulator material is arranged in a toroid shaped flexible housing, and where the flexible housing comprises a central opening, a diameter of the central opening is adjusted in response to the phase of the regulator material.

16. The engine system of claim 14, wherein a flow rate of fluid through the passage is inversely proportional to the temperature of the fluid, and where the flow rate decreases as the temperature of the fluid increases, and where the flow rate increases as the temperature of the fluid decreases.

17. The engine system of claim 14, wherein the conduit is a radiator bypass passage and where the three-way valve adjusts the flow of coolant through the radiator bypass passage, wherein the temperature of the fluid is greater than the predetermined temperature following completion of a cold-start of an engine of the engine system.

18. The engine system of claim 14, wherein the cooling system comprises coolant, and where the at least one conduit is a supply conduit to a transmission warm-up unit and where the three-way valve adjusts the flow of coolant through the supply conduit.

19. The engine system of claim 14, wherein the at least one conduit is a return conduit shaped to flow coolant from a transmission warm-up unit to the cooling system, and where the three-way valve adjusted the flow of liquid through the return conduit.

20. The engine system of claim 14, wherein the three-way valve is free of electrical connections.
